(19) United States
(12) Patent Application Publication
(10) Pub. No.: US 2025/0367732 A1
(43) Pub. Date: Dec. 4, 2025

(54) TILT PROTECTION FOR POWDER MATERIAL BOTTLES

(71) Applicant: DMG MORI ADDITIVE GmbH, Bielefeld (DE)

(72) Inventors: Guido ADAM, Paderborn (DE); Roman-Max MÖHLEN, Paderborn (DE)

(21) Appl. No.: 18/875,681

(22) PCT Filed: Dec. 11, 2023
(86) PCT No.: PCT/EP2023/085148

§ 371 Date: Dec. 16, 2024

(30) Foreign Application Priority Data
Dec. 14, 2022 (DE) 10 2022 133 294.2

(51) Int. Cl. B22F 12/50; B29C 64/153; B29C 64/255; B29C 64/321; B33Y 40/00

(52) U.S. Cl. CPC B22F 12/50; B29C 64/153; B29C 64/255; B29C 64/321; B33Y 40/00

(57) ABSTRACT

Tipping protection (1) for a machine for producing formed bodies by building up layers of powder material comprises a hold-down device (11) for holding a powder material bottle (2) coupled to a filling interface (3) of the machine and a device coupled to the hold-down device (11) for generating a holding force. The hold-down device (11) is arranged in a first state at a first position (Z1) in order to enable a coupling or decoupling of a powder material bottle (2) to or from the filling interface (3). The hold-down device (2) is arranged in a second state at a second position (Z2) in order to transmit the holding force to a powder material bottle (2) coupled to the filling interface (3).

The present invention relates to a tilt protection for a machine for producing formed bodies by building up layers of powder material. In particular, when filling a material powder container of the machine, it is intended to prevent a material powder bottle from tipping over or falling down.

Machines for selective laser melting (SLM) produce components (formed bodies) in layers of powder material. In this case, the powder material is applied, for example, in a thin layer on a base plate and then locally completely remelted by means of laser radiation. During solidification, a solid material layer forms. Subsequently, the base plate is lowered by the amount of a layer thickness and a powder layer is applied again. This process is repeated until the component is completely built up in layers. The finished component is then cleaned of excess powder and further processed as required.

Furthermore, there are laser processing machines for additive manufacturing with a powder nozzle which delivers the powder material in a targeted manner to the processing location where it is melted in the focus of a laser beam in order thus to additively produce a formed body.

A generic device for producing molds by building up layers of powdered material is disclosed, for example, in European patent No. EP 2 052 845 B1.

The present application relates to a tilt protection for machines in which a formed body is additively constructed by melting a material powder, in particular by means of laser radiation. The material powder can be, in particular, a metal powder or a plastic powder. In summary, the term “additive manufacturing machine” is used below for such machines.

The powder material used in an additive manufacturing machine is generally stored in a powder material tank which has to be refilled when the powder material is consumed. The powder material tank is filled, for example, via a filling opening or a filling interface. A powder container or a powder material bottle can be placed on such a filling interface for filling. A typical powder container can have a mass of up to approximately 25 kg in the fully filled state. Furthermore, it is not unusual for the filling interface to be able to be at a height of approximately 2 m, as a result of which the process of filling can pose a risk of injury to the worker entrusted with it.

The term “powder material bottle” is used in the present application for the sake of simplicity of the description and is not intended to restrict the shape of the powder container to that of a bottle. The term “powder material bottle” also comprises other shapes of powder containers or powder containers which are not bottle-shaped, such as, for example, wide-necked barrels or the like.

In the present application, “worker” means, in particular, a person who brings the powder container into interaction with the filling interface for filling the main tank.

In particular, there is a risk during filling that the powder container tips over and/or falls down, as a result of which the worker can be injured. There is therefore a need to prevent the container from tipping over and/or falling down in order to reduce a risk of injury to the worker.

The problems known in the prior art are to be overcome according to the invention by a tilt protection according to claim 1. Preferred embodiments of the present invention are the subject matter of the dependent claims, the appended drawings and the following description of exemplary embodiments.

The tilt protection comprises a hold-down device for holding a powder material bottle (powder container) coupled to a filling interface of the machine. The state “coupled” can refer to a state in which the powder material bottle is only placed or attached to a filling interface but not yet fixedly connected. As a result of the hold-down device holding the powder material bottle, tipping over or falling down of the powder material bottle can be prevented before the powder material bottle is fixedly screwed. As a result, a risk of injury to a worker can be reduced. In addition, the worker has both hands free in order to reliably produce the connection of the powder container to the filling interface

The hold-down device is coupled to a device for generating a holding force. The holding force serves to hold the powder material bottle. The holding force can be generated, in particular, by a spring or a weight.

The hold-down device is arranged in a first state at a first position in order to enable a coupling or decoupling of a powder material bottle to or from the filling interface. In other words, the hold-down device can be brought to the first position, for example, by displacing the hold-down device and/or rotating the hold-down device. If the hold-down device is located at the first position, the powder material bottle can be inserted or removed without being impeded by the hold-down device. In other words, the distance of the hold-down device in the first position from the filling interface is preferably greater than a maximum length of a powder material bottle.

According to a preferred embodiment, the hold-down device can be fixed at the first position. For this purpose, a latching mechanism or the like can be provided, which can be released, for example, by a lever. The latching mechanism can be, for example, part of kinematics described below.

In a second state, the hold-down device is arranged at a second position. In this position, the hold-down device contacts a powder material bottle coupled to the filling interface in order to transmit the generated holding force to the powder material bottle.

The device for generating the holding force can have a kinematics which can guide a movement of the hold-down device. The movement can comprise a rotational and/or translational movement. For example, the kinematics guides a linear displacement of the hold-down device along an axis or a rotation about the axis.

The device for generating the holding force generates the holding force with which the powder container is prevented from tipping over or falling down in the state not connected to the filling interface. The holding force can be generated, for example, by a spring which is expanded or compressed in accordance with the linear displacement of the hold-down device, so that a counterforce proportional to the linear displacement is generated. The counterforce counteracts the linear displacement of the hold-down device starting from a starting position (first position).

In alternative embodiments, instead of a spring, a weight can be used which generates a holding force by a corresponding weight force. The advantage here is that the weight force is always the same regardless of the position of the hold-down device.

If no powder material bottle is coupled to the filling interface, the hold-down device can be located in the first position. The first position can also be referred to as the starting position. The hold-down device can preferably be displaced from the starting position only in one direction, for example parallel to the force of gravity.

According to a preferred embodiment, the hold-down device can be moved in a region between the first position and a maximum deflection referred to as the third position.

When a spring is used, the spring force according to the preferred embodiment can be equal to zero in the third position or the spring force is preferably very small.

From the third position, the hold-down device can preferably be displaced counter to a component of the holding force parallel to the force of gravity. The direction of the displacement is defined here as the positive direction. This positive direction can be referred to, for example, as the positive Z direction. The direction of the holding force acts accordingly in the negative direction. In preferred embodiments, the direction of the holding force is parallel to the weight force.

When receiving a powder material bottle, the hold-down device is preferably moved counter to the holding force in the positive direction along the axis. A maximum deflection achieved during insertion of the powder material bottle can correspond to the first position. This maximum deflection can be dependent on a geometry of the powder material bottle, for example the length thereof.

When a spring is used, the spring is preferably a compression spring. This has the advantage that the maximum deflection during displacement of the kinematics can be limited by the spring without there being the risk of damaging the spring by excessive pulling.

After the coupling of the powder material bottle to the filling interface, the hold-down device can be displaced from the first position, for example in the negative Z direction along the axis, to a second position. In this second position, the hold-down device exerts the holding force caused by the device for generating the holding force (e.g. a spring or a weight) on the powder material bottle and therefore prevents the powder material bottle from tipping over or falling down.

According to a preferred embodiment, the hold-down device comprises a receptacle for the powder material bottle which, by virtue of its geometry, can hold a multiplicity of different powder material containers with different geometries and can prevent them from tipping over. For this purpose, the geometry is designed, for example, such that it tapers from its lower opening in the positive direction, such that powder containers with different diameters can be held by being brought into contact with the hold-down device at a point in the taper according to their dimensions. For example, hollow cones or hollow pyramids, which can preferably be rotationally symmetrical, are recommended as geometry.

According to a preferred embodiment, the receptacle can have the shape of a hollow cone. Such a shape can advantageously be adapted to powder material bottles with different diameters.

The kinematics can preferably have a stop which can limit a displacement of the hold-down device or a rotation of the hold-down device. The stop can have the effect, for example, that the hold-down device can be displaced from the second position only in the direction of the second position, that is to say in the negative direction.

Additionally or alternatively, the stop can be designed such that it limits a displacement of the hold-down device in such a way that a minimum distance between the hold-down device and the filling interface can be ensured, which can prevent a collision between the filling interface and the hold-down device, on the one hand, and can facilitate the insertion of the powder material bottle, on the other hand.

The kinematics can preferably have one or more bearings for guiding the axis. The axis can be designed to be rod-shaped or rail-shaped, for example. The bearings preferably predetermine the direction of displacement and can prevent tilting during the displacement of the kinematics.

According to a preferred embodiment, the bearing is a plain bearing or a ball bearing, for example. Such bearings can ensure a secure and low-friction guiding of the kinematics during the displacement.

A powder material container according to the invention for a machine for producing formed bodies by building up layers of powder material comprises a powder material tank for storing powder material and a filling interface for filling the powder material tank with powder material. According to the invention, the powder material container has a tilt protection according to the invention according to one of the aspects described herein.

The powder material container can be part of a machine for producing formed bodies, for example a SLM machine or another additive manufacturing machine, or can be coupled as an independent module to such a machine in order to supply the machine with powder material.

The filling interface can have a pipe section connected to the powder material tank which serves as a line for filling the powder material tank. The pipe section preferably has a closable valve.

The filling interface can have a closable coupling for coupling a powder material bottle. A powder material bottle can be inserted into the filling interface and a secure connection between filling interface and powder material bottle can be produced by closing the coupling. After the coupling, for example, the valve on the filling interface and a valve on the powder material bottle can be opened in order to allow the powder material to flow out of the powder material bottle into the powder material tank.

A machine according to the invention for producing formed bodies by building up layers of powder material has a powder material container described above.

### BRIEF DESCRIPTION OF THE FIGURES

Further advantageous embodiments are described in more detail below with reference to an exemplary embodiment which is illustrated in the drawings but to which the invention is not restricted.

There are shown schematically:

FIG. 1 FIG. 1 illustrates an exemplary embodiment of a tilt protection according to the invention.

FIG. 2 FIG. 2 illustrates a state during the coupling of a powder material bottle.

FIG. 3 FIG. 3 shows a coupled powder material bottle with a small diameter, which is held by the tilt protection according to the invention.

FIG. 4 FIG. 4 shows a coupled powder material bottle with a large diameter, which is held by the tilt protection according to the invention.

### DETAILED DESCRIPTION OF THE INVENTION WITH REFERENCE TO EXEMPLARY EMBODIMENTS

In the following description of a preferred embodiment of the present invention, identical reference signs denote identical or comparable components.

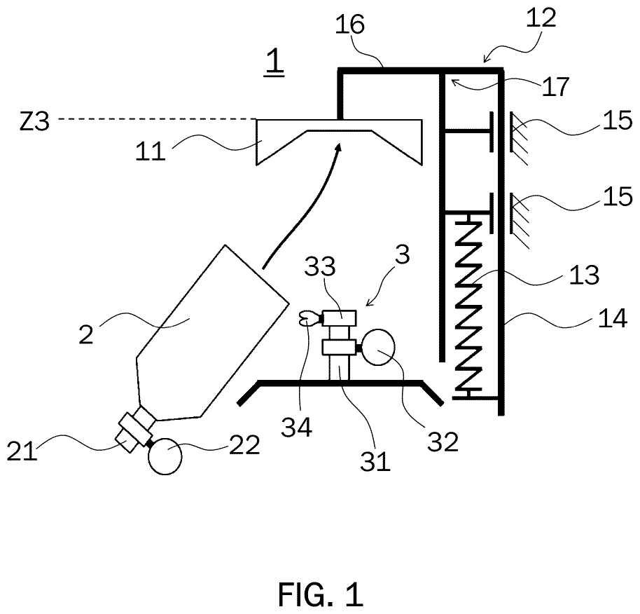

FIG. 1 shows a schematic illustration of a tilt protection 1 according to an exemplary embodiment of the invention. The tilt protection 1 can be installed, for example, in a powder material cabinet of an additive manufacturing machine in order to prevent tipping over and/or falling down of a powder material bottle 2.

The tilt protection 1 comprises a hold-down device 11 which is coupled to a device for generating a holding force 12 which has a kinematics. The kinematics comprises an axis 14 which is linearly displaceable along a vertical direction in FIG. 1 by means of two bearings 15.

The vertical orientation illustrated in the exemplary embodiment is to be understood by way of example and not as restrictive.

In the exemplary embodiment illustrated, the device 12 for generating the holding force comprises a spring 13 which, when deflected, generates a spring force which becomes a holding force.

The axle 14 has an L-shaped arm 16 at an upper end, which arm carries the hold-down device 11. At a lower end, the axle 14 is coupled to the spring 13 which generates a corresponding counterforce during the displacement of the axle 14. FIG. 1 shows the hold-down device 11 in a starting position referred to as the third position Z3. In this third position Z3, the arm 16 rests on a stop 17 which prevents a movement further downward.

In alternative embodiments, instead of the spring 13 or in addition to the spring 13, a weight can also be used in order to generate the holding force.

The hold-down device 11 shown has the shape of a rotationally symmetrical hollow cone, such that it is suitable for receiving a base of powder material bottles 2 of different sizes. In other alternative embodiments, the receptacle of the hold-down device 11 can also have the shape of a hollow pyramid, for example.

The process of coupling a powder material bottle 2 to a filling interface 3 of a powder material container of an additive manufacturing machine is described by way of example below with reference to FIGS. 1 to 3.

FIG. 1 shows an initial state in which a powder material bottle 2 is not yet coupled to the filling interface 3. Here, the hold-down device 11 is located at the third position Z3. The spring 13 is relaxed or has a slight prestress. The L-shaped arm 16 of the kinematics 12 rests on the stop 17. In the illustrated embodiment, the kinematics 12 are additionally pulled downward by the force of gravity.

The powder material bottle 2 comprises an interface 21 for coupling to the filling interface 3.

Furthermore, the powder material bottle 2 has a valve 22 which can be opened by rotation in order to allow the powder material to flow out of the powder material bottle 2.

The filling interface 3 comprises a pipe section 31 which is connected to the powder material container. A valve 32 which can be opened or closed by rotation is arranged on the pipe section 31. Furthermore, the filling interface 3 has a coupling 33 which serves to connect to the interface 21 of the powder material bottle 2. The coupling 33 can be opened or closed via a screw 34.

In a first step, the worker manually pivots the powder material bottle 2, as indicated by the arrow in FIG. 1, into the tilt protection 1 and brings the base of the powder material bottle 2 into contact with the hold-down device 11. The upwardly pointing base of the powder material bottle 2 presses against the hold-down device 11, as a result of which the kinematic system 12 is displaced upwardly. The spring 13 is compressed by the displacement.

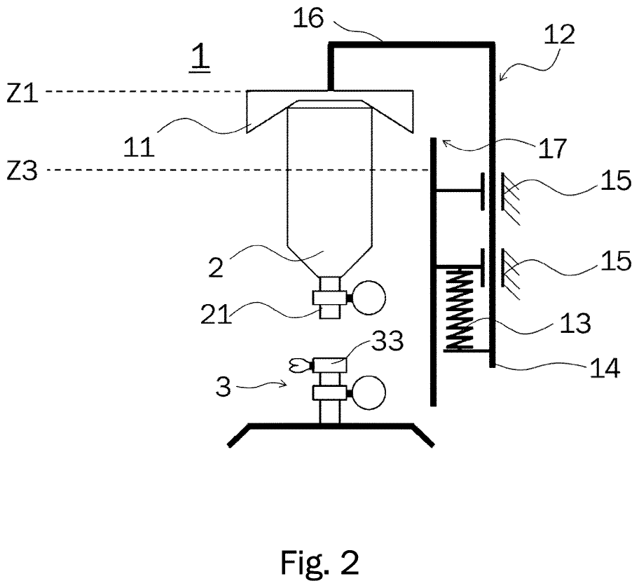

FIG. 2 shows a state after the first step. The spring 13 is compressed here. The hold-down device 11 is located at a position referred to as the first position Z1. The L-shaped arm 16 has an indefinite distance from the stop 17. The compressed spring 13 limits the displacement path of the kinematics 12. The axis 14 of the tilt protection 1 is guided during the displacement by two bearings 15, which can be designed as plain bearings or ball bearings, for example.

In the next step, the worker aligns the powder material bottle 2 coaxially with respect to the filling interface 3 in the state shown in FIG. 2, such that the interface 21 of the powder material bottle 2 can be inserted into the coupling 33.

Subsequently, the worker can couple the powder material bottle 2 to the filling interface 3. For this purpose, the worker places the powder material bottle 2 with the interface 22 on the filling interface 3. The kinematic system 14 is displaced downwardly again, wherein the spring 13 relaxes by the distance between Z1 and Z2. The hold-down device 11 can preferably remain in contact with the powder material bottle 2 continuously as the powder material bottle 2 approaches the filling interface 3.

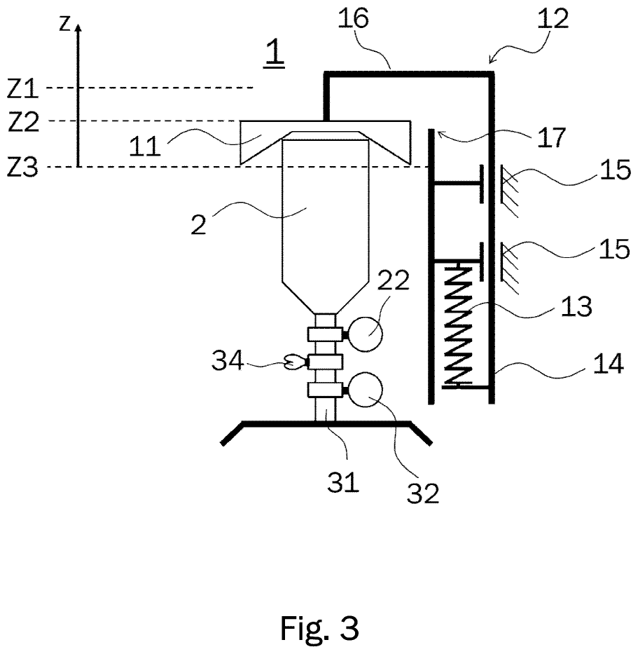

In the state shown in FIG. 3 (second state), the hold-down device 11 is located at a position referred to as the second position Z2, which is located between the first position Z1 and the third position Z3 and depends on the size of the powder material bottle 2. The L-shaped arm 16 does not yet rest on the stop 17 here.

FIG. 3 also shows a Z axis which indicates the positive direction of the displacement. The displacement from Z1 to Z2 therefore takes place in the negative Z direction. Furthermore, the positions Z1 and Z2 are illustrated for comparison with Z3.

When lowering from the first position Z1 to the second position Z2, the spring 13 is relaxed by the corresponding distance between Z1 and Z2. However, the spring 13 continues to generate a sufficient holding force in position Z2 in order to prevent the powder material bottle 2 from tipping over. As soon as the powder material bottle 2 is inserted with the interface 22 into the coupling 33, the worker can release the powder material bottle 2. The powder material bottle 2 is now held at its base by the tilt protection 1.

In this state, the worker has both hands free in order to fixedly screw the coupling 33 by means of the screw 34. Subsequently, the two valves 22 and 32 on the powder material bottle 2 and on the filling interface 3 can be opened so that the powder material can flow into the powder material container.

In an alternative embodiment, the hold-down device can be locked in the first position Z1. For this purpose, the kinematics can have a latching mechanism which can be released, for example, by a lever. The sequence of the insertion of a powder material bottle 2 here proceeds in a manner similar to that described above.

Firstly, the worker can lock the hold-down device in the first position Z1 as the starting position (first state, similar to FIG. 2). It can then couple the powder material bottle 2 to the filling interface 3 without having to actively press the hold-down device 11 upwardly.

It then releases the latching mechanism and the hold-down device 2 is moved downwardly (in the negative Z direction) by the spring force and/or the weight force to the second position (second state, see FIG. 3), where the receptacle of the hold-down device 11 comes into contact with the base of the powder material bottle 2 and holds the latter owing to the generated holding force.

The embodiment illustrated in the figures can also permit a rotational movement of the hold-down device about the axis 14. For example, it can be advantageous to rotate the hold-down device 11 about the axis 14 in order to couple a large powder material bottle 2 to the filling interface 3.

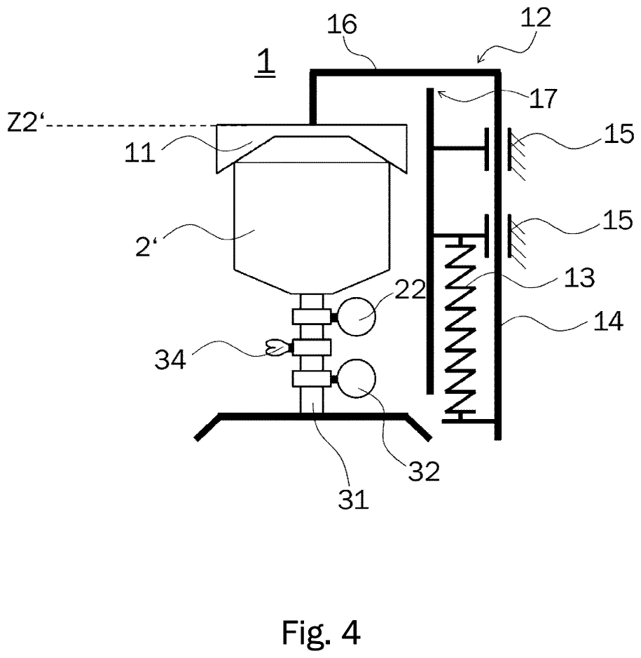

FIG. 4 shows a further example of a state corresponding to FIG. 3 with a powder material bottle 2′ which has a larger diameter than the powder material bottle 2 from FIG. 3. Owing to the hollow cone shape of the receptacle of the hold-down device 11, the larger base of the powder material bottle 2′ can also be held by the hold-down device 11.

Moreover, the powder material bottle 2′ in FIG. 4 is shorter than the powder material bottle 2 in FIG. 3, such that the resulting position Z2′ is located below position Z2 and therefore lies closer to position Z3. The kinematics 12 therefore allow the tilt protection 1 to be used with powder material bottles of different lengths.

It should be noted here that the figures show the hold-down device 11 in cross section. The receptacle of the hold-down device 11 is preferably rotationally symmetrical, such that, in particular, a circular bottle base of the powder material bottle 2 can come into contact with the receptacle of the hold-down device 11 along the edge thereof. The hold-down device 11 can therefore receive and hold powder material bottles 2 of different sizes in diameter.

A multiplicity of different powder material bottles can therefore be used with the tilt protection 1. The receptacle of the hold-down device 11 can receive different diameters, on the one hand, and the kinematics 12 can be adapted to different lengths, on the other hand.

The inner side of the receptacle can preferably be coated with rubber or another material in order to increase the adhesion between the powder material bottle 2 and the receptacle, such that slipping of the powder material bottle 2 in the receptacle can be prevented.

For the sake of clarity, not all reference signs from FIG. 1 are illustrated in FIGS. 2 to 4.

The features disclosed in the above description, the claims and the drawings can be of importance both individually and in any desired combination for the implementation of the invention in its various embodiments.

1. A tilt protection for a machine for producing formed bodies by building up layers of powder material, comprising:
a hold-down device for holding a powder material bottle coupled to a filling interface of the machine; and
a device coupled to the hold-down device for generating a holding force, wherein:
the hold-down device is arranged in a first state at a first position in order to enable a coupling or decoupling of a powder material bottle to or from the filling interface; and
the hold-down device is arranged in a second state at a second position in order to transmit the holding force to a powder material bottle coupled to the filling interface.

2. Tilt protection according to claim 1, wherein the hold-down device has a receptacle which is configured to hold powder material bottles of different sizes and/or geometries.

3. Tilt protection according to claim 2, wherein the receptacle has the shape of a hollow cone, a hollow truncated cone, a hollow pyramid or a hollow truncated pyramid.

4. Tilt protection according to claim 1, wherein the device for generating the holding force has a spring.

5. Tilt protection according to claim 4, wherein the spring is a compression spring.

6. Tilt protection according to claim 1, wherein the device for generating the holding force has a weight.

7. Tilt protection according to claim 1, wherein the device for generating the holding force has a kinematics which is configured to guide a linear and/or rotational movement of the hold-down device along and/or about an axis.

8. Tilt protection according to claim 7, wherein the kinematics has a stop in order to limit the linear and/or rotational movement of the hold-down device.

9. Tilt protection according to claim 7, wherein the kinematics has one or more bearings and/or guides for guiding the axis.

10. Tilt protection according to claim 9, wherein the bearing is a plain bearing or ball bearing.

11. A powder material container for a machine for producing formed bodies by building up layers of powder material, comprising:
a powder material tank for storing powder material;
a filling interface for filling the powder material tank with powder material; and
a tilt protection according to claim 1.

12. Powder material container according to claim 11, wherein the filling interface has a pipe section connected to the powder material tank.

13. Powder material container according to claim 12, wherein the pipe section has a closable valve.

14. Powder material container according to 11, wherein the filling interface has a closable coupling for coupling a powder material bottle.

15. A machine for producing formed bodies by building up layers of powder material, characterized in that the machine has a powder material container according to claim 11.
